(19) United States
(12) Patent Application Publication
(10) Pub. No.: US 2025/0162695 A1
(43) Pub. Date: May 22, 2025

(54) Vessel Movement Prediction

(71) Applicant: WiseTech Global (Licensing) Pty Ltd, Alexandria, New South Wales (AU)

(72) Inventors: Bogdan Vatulya, Alexandria (AU); Tobias Däullary, Alexandria, New South Wales (AU)

(21) Appl. No.: 18/837,803

(22) PCT Filed: Feb. 10, 2023
(86) PCT No.: PCT/AU2023/050088

§ 371 Date: Aug. 12, 2024

(30) Foreign Application Priority Data
Feb. 11, 2022 (AU) 2022900286

(51) Int. Cl. B63B 49/00; B63B 79/20; B63B 79/40; G06F 16/28; G06F 16/29

(52) U.S. Cl. CPC B63B 49/00; B63B 79/20; B63B 79/40; G06F 16/285; G06F 16/29; B63B 2213/02

(57) ABSTRACT

This disclosure relates to a method for predicting vessel movement as performed by a processor. The processor creates historical trip data by receiving historical location data indicative of historical locations of vessels; identifying stop points in the historical locations indicative of ports where the vessels stopped; splitting the historical location data for the vessels into sequences of historical locations between the stop points; and clustering the sequences of historical locations to determine representative sequences, each representative sequence representing one of multiple clusters. The processor then predicts future vessel movement by receiving a current geographical location for a current trip of a tracked vessel, selecting one of the representative sequences that is close to the geographical location, and predicting future movement of the tracked vessel as proceeding along the selected one of the representative trips.

### CROSS-REFERENCE TO RELATED APPLICATIONS

The present application claims priority from Australian Provisional Patent Application No 2022900286 filed on 11 Feb. 2022, the contents of which are incorporated herein by reference in their entirety.

### TECHNICAL FIELD

This disclosure relates to the prediction of vessel movements.

### BACKGROUND

A large number of vessels, such as cargo ships, are constantly transporting goods around the globe. In order to ensure the safe and efficient operation of those vessels, it is important to monitor their locations over time, which is referred to as tracking. One existing tracking solution is based on the automatic identification system (AIS). The AIS is a maritime communications device. It uses the very high frequency (VHF) radio broadcasting system to transfer data. AIS equipped vessels (shipborne AIS) and shore based stations (non-shipborne AIS) can use it to send and receive identifying information. This identifying information can be displayed on an electronic chart, computer display, chart plotter or compatible navigation radar.

AIS improves navigation safety and environmental protection by assisting in the effective navigation of ships. One aim of AIS is to aid in situational awareness and therefore provide a means to assist in collision avoidance. To that end, AIS data from one vessel is received by all vessels within VHF communication range of the sending vessel. The receiving vessels can display all received AIS data on one screen to provide a real-time situational awareness of vessels in the vicinity without the need for data network connectivity.

In addition to the location-specific processing and display, it is possible to receive AIS data at various stations on land and save that data for further use. In particular, it is possible to transmit that data to a server, where AIS data from multiple different receiving stations is collated into a single dataset of vessel locations globally.

While this dataset enables to determine the accurate location of each vessel in real-time, it cannot provide an indication of any future movements, such as which of multiple possible routes the vessel will follow.

Using current methods it is difficult to determine which route a vessel is on. Further, current methods are not able to detect anomalies where vessels deviate from common routes. One difficulty with addressing these problems is that most routes are not formally defined, except in busy areas like the English channel. Further, there may be a variation depending on weather and other circumstances. It is difficult for current methods based on AIS data to predict the vessel movement. As a result, anomaly detection unreliable. That is, anomalies would be detected in the majority of cases (high false positive) because alternative but valid routes are not known a priori.

Further, there is satellite AIS (S-AIS)—however most ships are not equipped with a S-AIS transceiver; that means they will only have connection to AIS when they are close to ports, in range of a terrestrial AIS (T-AIS) transmitter. Furthermore, S-AIS satellites have a restricted frequency band with a few channels, so only few ships will be able to connect to it in the first place.

So the AIS data will have a lot of points at the beginning, then nothing for a long time, and then lots of points at the end, which leads to inaccuracies predicted shipping routes.

A further problem with AIS data is that the number of available data points is immense. Therefore, it is computationally difficult to process all that data efficiently. In particular, when the analysis result is to be applied to a current vessel location, it is important that the processing finishes within a reasonable time frame.

Therefore, there is a need for more accurate vessel tracking that accurately predicts vessel movement and is also computationally efficient since the data available on vessel movement is large and can easily lead to computational overload.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

This disclosure provides a method for improved prediction of vessel movement, such as anomaly detection. The method clusters historical trips to determine representative or average trips, which could be interpreted as common routes. It is then possible to estimate which of the routes the vessel will take given its current location. More particularly, the disclosed methods first splits the data into trips between stop points. The advantage is that clustering is computationally efficient as a number of optimised algorithms exist, which means even a very large dataset like historical locations of thousands of vessels can be processed relatively quickly. Further, the route selection enables accurate anomaly detection, which is another technical advantage. Further, actions can be triggered by the departure determination, such as automatic control of cranes, trucks, trains and other port equipment.

A method for predicting vessel movement, the method comprising:
creating historical trip data by:
   receiving historical location data indicative of historical locations of multiple vessels;
   identifying stop points in the historical locations indicative of ports where the multiple vessels stopped;
   splitting the historical location data for each the multiple vessels into multiple sequences of historical locations between the stop points, each of the multiple sequences representing one of multiple historical trips of the respective vessel;
   clustering the multiple sequences of historical locations to determine multiple representative sequences, each representative sequence representing one of multiple clusters;
predicting future vessel movement by:
   receiving a current geographical location for a current trip of a tracked vessel;
   selecting one of the multiple representative sequences that is close to the geographical location;
   predicting future movement of the tracked vessel as proceeding along the selected one of the multiple representative trips.

In some embodiments, the method comprises, during creating the historical trip data:
storing each of the multiple sequences as a separate record on a database;
performing the clustering by performing a query on the database for one or more stop points to retrieve records holding sequences comprising the one or more stop points of the query and clustering the sequences retrieved from the database.

In some embodiments, the database is a relational database.

In some embodiments, the method further comprises, during creating the historical trip data, filtering the historical location data by:
determining an information content in a time difference between the historical locations in each of the multiple sequences; and
selecting one or more of the multiple sequences that have a high information content for the clustering.

In some embodiments, determining the information content comprises determining an entropy of the historical locations.

In some embodiments, the method further comprises selecting one or more of the multiple historical trips that have a small variation in time difference between the historical locations.

In some embodiments, the method further comprises determining each representative sequence by calculating a barycentre average of the sequences of historical locations in each of the multiple clusters.

In some embodiments, the clustering comprises determining a similarity by warping the historical locations of a first sequence to determine an optimal match with the historical locations of a second sequence.

In some embodiments, the method further comprises a comparison between the prediction and an updated geographical location and determining an anomaly in the vessel movement based on the comparison.

In some embodiments, the method further comprises generating a user interface representing the selected one of the multiple representative sequences.

In some embodiments, the prediction of vessel movement comprises a prediction that the tracked vessel will follow the selected one of the multiple representative sequences.

In some embodiments, the stop points are one or more of vessel origin and vessel destination.

In some embodiments, the method further comprises filtering the historical location data by one or more of vessel origin and vessel destination to select historical locations related to each of the multiple historical trips.

In some embodiments, the method further comprises using respective stop points for the one or more of vessel origin and vessel destination.

In some embodiments, the method further comprises triggering, based on the prediction, events in a logistics application.

In some embodiments, the vessel movement is predicted by a first software system and the method further comprises generating, by the first software system, an event to notify a second software system of the predicted vessel movement.

In some embodiments, the method further comprises triggering, by the event, an action performed by the second software system.

In some embodiments, predicting the future movement of the vessel comprises calculating a probability of the future movement.

In some embodiments, the probability is indicative of a weight associated with the selected one of the multiple representative trip.

In some embodiments, the weight is indicative of a number of sequences in the cluster represented by the selected one of the multiple representative trips.

In some embodiments, the method further comprises storing the received historical location data on a relational database as multiple data records comprising one record for each of the historical locations.

In some embodiments, identifying the multiple historical trips comprises creating a field value for each of the records in the relational database indicative of a trip identifier to indicate an association between a data record and one of the multiple historical trips.

In some embodiments, clustering comprises creating a field value indicative of an association between trip identifiers and cluster identifiers to indicate which trip belongs to which cluster, and determining the multiple representative sequences comprises: querying, based on one cluster identifier, the relational database for historical locations associated with a trip identifier that is associated with the one cluster identifier, and averaging the returned sequences, as indicated by trip identifiers, to determine one of the multiple representative sequences.

In some embodiments, performing the method comprises running a first service and a second service, the first service is configured to perform the steps of receiving the historical location data, identifying stop points, and splitting the historical location data into the multiple sequences, the first service further stores the multiple sequences on a database; and the second service is configured to retrieve the sequences from the database for the clustering of the sequences.

Software, when executed by a computer, causes the computer to perform the above method.

A computer system for predicting vessel movement comprises:
a data store configured to store historical location data indicative of historical locations of multiple vessels;
a processor configured to create historical trip data by:
   identifying stop points in the historical locations indicative of ports where the multiple vessels stopped;
   splitting the historical location data for each the multiple vessels into multiple sequences of historical locations between the stop points, each of the multiple sequences representing one of multiple historical trips of the respective vessel;
   clustering the multiple sequences of historical locations to determine multiple representative sequences, each representative sequence representing one of multiple clusters;
the processor being further configured to predict future vessel movement by:
   receiving a current geographical location for a current trip of a tracked vessel;
   selecting one of the multiple representative sequences that is close to the geographical location;
   predicting future movement of the tracked vessel as proceeding along the selected one of the multiple representative trips.

Optional features provided above in relation to the method are equally optional features relating to the software and the system.

### BRIEF DESCRIPTION OF DRAWINGS

An example will now be described with reference to the following drawings:

FIG. 1 illustrates an example shipping scenario.

FIG. 2 illustrates a sequence of historical locations.

FIG. 3 illustrates multiple sequences indicated as lines through the historical locations.

FIG. 4 illustrates geographically similar sequences with different sampling.

FIG. 5 shows an example implementation of dynamic time warping (DTW).

FIG. 6 illustrates an index grid of corresponding locations during DTW.

FIG. 7 illustrates an example implementation of a windowed DWT.

FIG. 8 illustrates an example pseudo-code for the DTW Barycenter Averaging (DBA) algorithm.

FIG. 9 illustrates the output result of the DBA algorithm.

FIG. 10 illustrates a current location of a vessel amongst different representative sequences from historical locations.

FIG. 11 illustrates a predicted path.

FIG. 12 illustrates a computer network.

FIG. 13 illustrates a method for predicting vessel movement.

FIG. 14 illustrates an example port.

### DESCRIPTION OF EMBODIMENTS

As stated above, current methods for vessel monitoring are often inaccurate. Therefore, this disclosure provides methods that can accurately predict vessel movements. More particularly, the disclosed methods can, based on only the collected data from the vessels over time, create representative trips and select one of those representative trips for a current location of a vessel. This provide a more accurate prediction of the travelled path. If data is collected for that particular vessel over time (which is often the case), then the comparison of the special trajectory against common routes can tell if the trajectory of that vessel has any abnormalities. Such abnormalities can be detected even when the vessel turns off its location transmitter for some time of its journey. Further, the number of vessels that are typically tracked is large, which means that computer systems that track those vessels can easily be overwhelmed if the computational complexity of the tracking software is not considered carefully. Therefore, the methods provided in this disclosure rely on clustering of trips (i.e. geometries of trajectories) of the vessels. This clustering is computationally efficient and therefore, reduces the overall burden on the used computer systems.

### Shipping Scenario

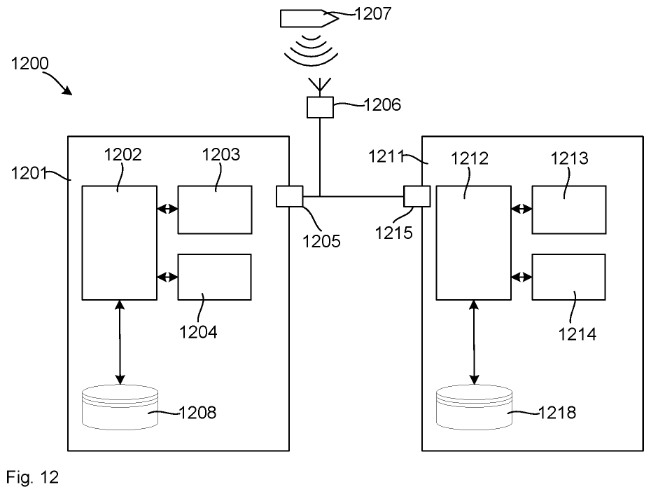

FIG. 1 illustrates an example shipping scenario 100 comprising a first port 101 and a second port 102. Multiple vessels travel between the first port 101 and the second port 102 while they repeatedly transmit their location, such as their GPS location over AIS. The locations of all vessels are received by a computer system, such as the computer system described below with reference to FIG. 12. The computer system stores the locations over time to build a collection of historical locations. Naturally, over time, this collection can become large since many vessels submit their locations relatively often, such as up to every 2 seconds for fast moving vessels. So if there are an estimated 17,000 cargo ships that transmit every 2 seconds, that amounts to 255 billion data points. If 6 bytes are used for each GPS location, this amounts to a storage requirement of about 1.5 terabytes of historical tracking data for a single year.

In order to store this large amount of data, a relational database, such as SQL, may be used noting that other databases may equally be employed. Other examples include the use of the parquet format (https://parquet.apache.org/) on S3-like distributed data storage system, which may be less complex and often more efficient if the dataset is large (terrabytes).

In the example of a relational database, there may be one table that holds all the tracking data. Each record comprises fields for longitude, latitude, origin, destination, timestamp and vessel identifier (ID). The database engine can then search the records efficiently. For example, the database can search for all records that have an identical origin and destination. Based on the timestamps the database can then determine which records belong to the same trip. That way, the database can add a further field holding a generated trip ID to more efficiently retrieve all records for a particular trip. The trip ID may also be allocated in real-time, in the sense that the database does not ingest the entire dataset at once (which is also possible), but receives the locations as they are transmitted from the vessels and thereby builds up the database over time.

As mentioned above, the database comprises records for multiple trips. A trip is defined as a movement between one port to another port. In that sense, for some trips first port 101 may be the port of origin (or simply ‘origin’ herein) and second port 102 may be the destination port (or simply ‘destination’ herein). For other trips, second port 102 may be the origin while first port 101 is the destination.

In FIG. 1 the multiple trips are indicated by dotted lines. An example trip 103 is highlighted in bold as an example. More particularly, the dots indicate the geographical locations (or simply ‘location’ herein) of the multiple vessels over time. These locations may be provided at regular intervals, such as every hour, or at irregular intervals such as every 30-60 minutes, noting that a higher frequency, such as every 5 minutes would improve accuracy. The locations may be determined by a global positioning system (GPS) sensor on board the vessels. In some examples, the GPS sensor determines the position and a radio communication device sends the location in real-time to a server. Real-time in this context means the GPS sensor sends the location before the next location is determined. That is, the GPS sensor sends the location every minute, for example. In yet another example, the GPS sensor records the location on a data store and the locations are then uploaded as a batch to the server when the vessel is at or near a port. For some of the methods disclosed herein it is not relevant whether the location data is current or historical and outdated.

It is noted that the multiple trips between origin 101 and destination 102 may be chosen for various reasons. For example, seasonal changes may make some passages impassable due to ice cover, for example. In other cases, channels may move due to movement of sand which changes routes over time. In yet another example, there may be currents that change the particular advantage of one route over another during certain periods of time. Further, there may be weather events, such as hurricanes, that change routes temporarily or cause captains to choose a different route than what they would normally choose. Climate change may affects routes as well. More particularly where ice melts due to climate change, new pathways may open in the arctic, for example. Further, the rise of the oceans due to glacier melting may increase clearance for the vessels in areas where the sea was too shallow previously. This would allow more efficient routes to be discovered.

These factors are difficult to consider automatically. Therefore, this disclosure provides for a data-driven method that automatically finds routes between ports and can updated those routes regularly. This way, the routes are dynamic and can react to changes in the environment. The route update is also automatic and does not require human intervention, which makes the method less error-prone. Further, more data points can be considered which would surpass the capability of the human brain.

### Trips and Sequences

As mentioned above, the scenario 100 comprises multiple trips. While each trip in FIG. 1 is represented by a dotted line, each trip can also be considered as a subset of geographical locations that are associated with that trip. In that sense, such a subset associated with a trip is also associated with an corresponding origin and a corresponding destination. This can be useful for filtering trips, subsets of locations or locations as described further below.

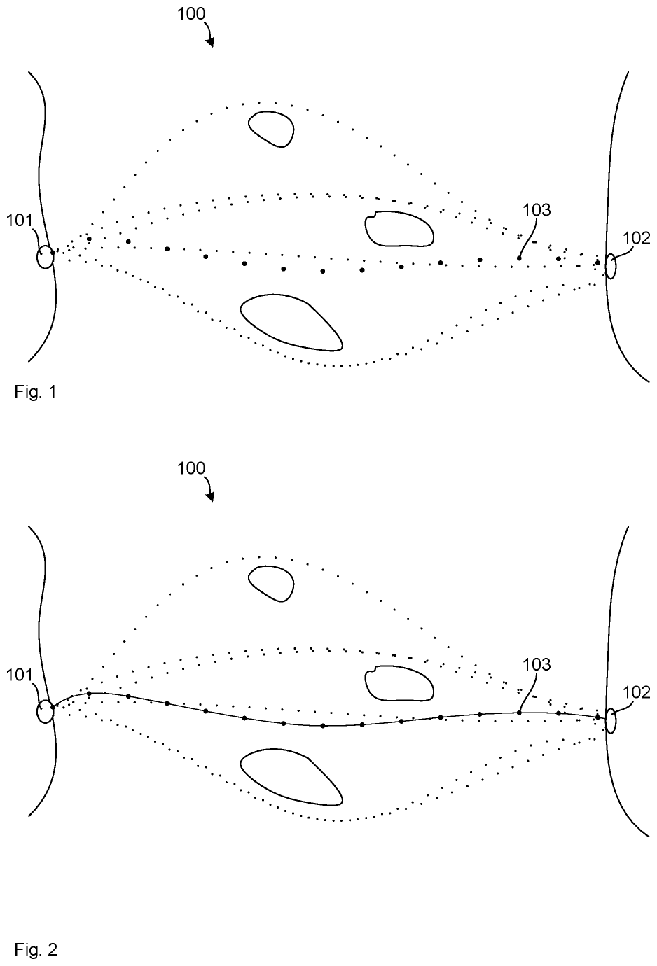

In another aspect, each trip is represented by a sequence of historical location. One sequence is indicated in FIG. 2 as a line through historical locations of trip 103. A sequence is an ordered list of historical locations that is ordered by a timestamp of the historical locations between an origin and a destination. Multiple trips between the same origin and destination result in multiple separate sequences. More particularly, a computer receives the historical location data which comprises multiple historical locations as data records, such as from AIS. The individual records typically do not indicate the trip to which they belong. That is, there is typically not a trip ID in the data records that would enable the computer system to readily allocate the data records to a specific trip.

Therefore, the computer system groups the data records first by vessel identifier, which is typically included in the data records. Each vessel ID is also provided with a destination port, so each received data record can be associated with that destination port. In another example, the data records are from the past and currently the vessel is heading for a different destination. As a result, the current vessel destination is not useful for historical locations. In that case, the computer system can query a sequence of destination ports of that vessel with associated timing information. The computer system can then retrospectively assign the destination to each of the historical locations.

Now, the computer system can further group the historical locations by destination port. As a result, the historical locations are grouped by vessel ID and destination port to thereby determine multiple sets of historical locations. In one example, these grouping operations are implemented efficiently as SQL statements. Since each location has a timestamp, the computer system can now sort the locations in each set into the sorted list that is described above as being a sequence of historical locations.

In some examples, a vessel may head for the same destination port during multiple different trips and it would be an aim to separate these trips into separate sequences. Therefore, computer system can first group the historical locations by vessel ID and then sort the locations by timestamp for each vessel ID. The computer system can then iterate over the locations to determine whether the destination port changes from one location to the next in time. Responsive to a change in the destination port, the computer system commences a new sequence, that is, splits the sequence so that a different sequence is created in response to a change in the destination port. This way, the historical locations for different trips are stored as separate sequences even where the destination ports are identical. This way, the computer system identifies multiple historical trips of the multiple vessels represented by respective sequences of historical locations in the historical location data.

In yet a further example, in particular where manually entered destination ports are unreliable, the computer system can determine destination ports automatically based on coordinates of ports from the data provider. The computer system then identifying stop points in the historical locations indicative of ports where the multiple vessels stopped.

For example, a sequence of a vessel has 12 historical locations:
oooooooooooo

The computer system found two stops in this sequence. One at location 4 and one at location 9:
oooo(port A)ooooo(port B)ooo

So, there is a segment from event 5 to event 9 that represents the vessel's voyage between two ports A and B. “Segment” is also a “sequence” in the sense that a segment is a type of sequence that is part of a longer recording of locations, with potentially more than one segment-sequence (or simply “segment”) in the same recording. In other words, computer system takes the locations between port A and port B as one sequence and assigns port B as the destination port to that sequence. The other two segments, one from index 1 to 4 and the other from index 10 to 12 are discarded as incomplete. I.e. the start at index 1 may not necessarily be the start of the vessel's journey. It could be in the middle of the voyage. And the last event at index 12 may be the current location of the vessel. Which might be in the middle of the ocean.

The method is efficient since the number of ports is negligible compared to the number of AIS events in the vessel voyage in general. There are a number of steps that follow to afford ranking of the resulting trajectories.

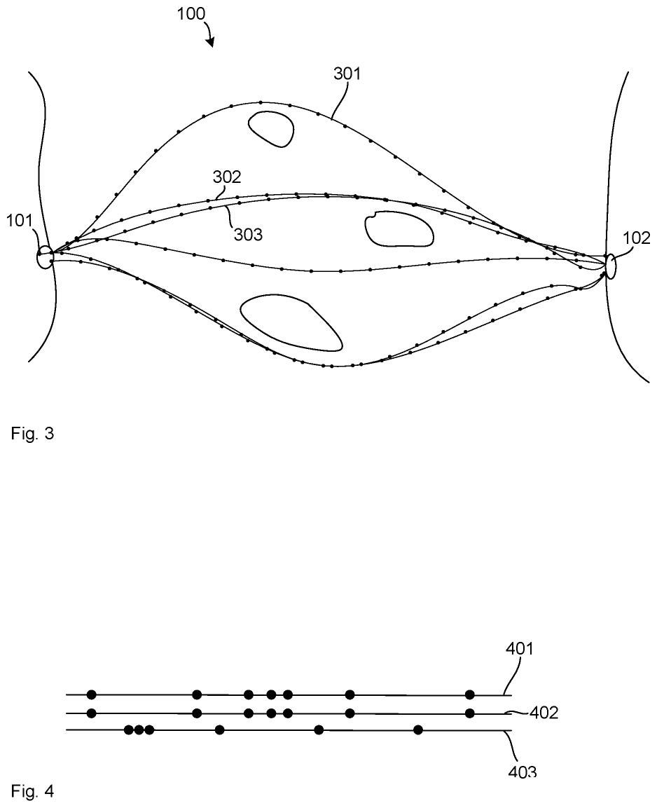

FIG. 3 illustrates the resulting multiple sequences indicated as lines through the historical locations. In other words, dots connected by a line in FIG. 3 belong to the same sequence. The computer system now determines a similarity between the sequences of historical locations. In the example of FIG. 3, sequence 301 is relatively dissimilar to sequence 302, while sequence 302 relatively similar to sequence 303.

### Filtering Sequences

In some examples, the number of segments is impractically large. Therefore, for each such segment, the computer system evaluates the below metrics to filter the segments, such as by selecting only the top segments according to these metrics. Such as the number of events, the length of the path in kilometres, the Z score of the length, the average timestamp delta between two adjacent events, the Z score of the average, the average speed for the segment and its Z score, the average distance entropy, the average timestamp delta entropy etc. In one example, the computer system does not discard any of the segments at this point. It only computes various metrics for them. And then saves the segments and their metrics to the database.

The second phase is the computation of common routes. For each existing port pair A and B, the computer system queries the database for top N segments currently ranked by the distribution entropy of the timestamp deltas. It was found that entropy is the best predictor of a quality segment on average. Another option would be to use Z-scores in addition to entropy or individually. For example, a Z-score close to 0 indicates a useful segment.

The entropy is information entropy as defined by Shannon in information theory. This yields good results because Shannon operates with a notion of a “surprise” when referring to information.

More specifically, AIS data providers provide data at a fixed resolution. E.g., every vessel has an event every hour. Some AIS data has geographical “bermuda triangles” where data is missing for all or most of the vessels. In the example where two points are 1 hour apart, a segment may be (‘o’ are AIS positions, ‘ ’ spaces are missing data values):

<port A>ooo oo oo ooooooooo oo<portB>

This segment has low entropy. The example of the segment with high entropy is plainly the one below

<port A>ooooooooooooooooooooooooooooooooooooooooooooooooooo<portB>

It has zero “surprises”. The timestamp delta distribution is uniform. Another example of a high entropy is

<port A>o o o o o o o o o o<portB>

The timestamp delta is significantly larger. But the distribution stays uniform. Switching data providers and getting higher or lower resolution would not impact the entropy value. The prediction of a good segment on average is the segment with high entropy (or if reinterpreted to fit the present problem—the segment with even distribution of AIS events across the timeline). The Shannon entropy can be calculated by

$$H ( X ) = - {\sum }_{i = 1}^{R} {p}_{i} ln {p}_{i}$$

or by using the Python method scipy.stats.entropy.

The computer system may fit any type of discrete numeric sequence Sₙ[x] with length l to resemble a probability density function. The nth value is scaled like this: n=S(n)/sum(S). To get an entropy value scaled to 1.0 independent of sequence length, logarithm with base l is chosen in the entropy formula. Shannon's formula uses log 2, as it is used for determination of channel capabilities based on a binary encoding (0, 1).

In one example: there is a timestamp difference distribution of (time between GPS coordinates):
1 hr-1 hr-15 hrs-1 hr-1 hr-1 hr. (length of 6)
   The computer scales each data point by the sum of the sequence, resulting in
[ 1/20, 1/20, 15/20, 1/20, 1/20, 1/20]

The entropy is the calculated as

$$H ( X ) = - ( 1 / 20 * {log}_{6} ( 1 / 20 ) * 5 + 15 / 6 * {log}_{6} ( 15 / 20 ) ) = 0.58$$

Now compare it to the uniform distribution 1 hr-1 hr-1 hr-1 hr-1 hr with length 5->[⅕, ⅕, ⅕, ⅕, ⅕]:

$$H ( X ) = - ( 1 / 5 * {log}_{5} ( 1 / 5 ) * 5 ) = 1.$$

Clearly the second distribution is more uniform than the first—in fact, perfectly uniform—and this is what is desired. The computer calculates entropy of all path segments like this and then e.g. remove every segment with entropy<0.8 (or any other threshold which is acceptable).

In another example, the base of the logarithm is the time length of the sequence and the computer system takes each existing location as a ‘1’ value in the distribution and each missing location as a ‘0’ value in the distribution. So for an example sequence of <port A>o oooooo<port B>, there are seven existing data points and one missing data points. This means the time length is 8 and the entropy is calculated as −7 Log₈(1/7)*1/7=0.94. In other words, the computer system takes the sequence of locations as a probability distribution and then applies the entropy calculation function to that probability distribution. The computer system then takes the top entropy sequences (e.g. top 10 or top 100) or all sequences above a threshold.

The computer system then performs DTW (see below) to produce a similarity matrix and feeds this similarity matrix to HDBSCAN (see below) and obtains clusters of segments. Finally, the computer system feeds each such cluster to compute DTW barycenters (see below) to get a single “average” route per cluster.

### Similarity Measure

It is noted that the distance between historical locations is generally not identical along a sequence or across different sequences. Reasons for this include that the timing of sending location updates is not always periodical but can change or be random. Further, some locations may be lost in transmission from the vessel due to poor radio reception, for example. Further, a change in a vessel's speed can lead to a different distance between subsequent locations. Finally, there may be an offset between two sequences since the timestamp of the very first location of the sequence is essentially random because most AIS transmitters are not synchronised with the vessel commencing a trip.

These reasons make it difficult to determine the similarity between two sequences. FIG. 4 illustrates three sequences 401, 402 and 403. All three sequences are relatively similar. Similarity in this example means that the historical locations of sequences lie on about the same path. In other words, the historical locations of a first sequence have a short distance from a path defined by the historical locations of a second sequence.

The path defined by the historical locations is a line through those locations. In a computer implementation, however, lines as such are typically difficult to represent using discrete data. In one example, the computer system determines a parametric characterisation, such as a polynomial or spline approximation of the historical locations. The computer system can then calculate a minimum distance of each historical location of a further sequence from that parametric characterisation and calculate a mean square error as an indication of similarity. That is, a small error indicates a high similarity.

In other examples, the historical locations are not approximated by a parameterised characterisation as that characterisation may be difficult to apply to all possible shapes of trips. Instead, the different sampling of sequences artificially increases the distance between sequences. FIG. 4 illustrates that problem. First sequence 401 and second sequence 402 are sampled identically. As a result, each location of the first sequence 401 is close (i.e. short distance) to the closest point in the second sequence 402, which results in a high similarity. However, second sequence 402 and third sequence 403 are sampled very differently. As a result, the locations of second sequence 402 are not very close to the locations of third sequence 403. As a result of this different sampling of locations over time, the similarity between first sequence 401 and second sequence 402 would be significantly higher than the similarity between second sequence 402 and third sequence 403. However, in reality the sequences should have the same similarity because both sequences 401, 403 are about the same distance away from the second sequence 402. This shows how the difference between locations of sequences can lead to a large error in the calculated similarity.

The above described problem does not occur in an abstract setting, since paths in general can be checked for similarity by in integral over their distance. In a computer implementation, however, paths are sampled by discrete points, which are the historical locations in this applications. Once the historical locations are the ‘anchor’ points defining the path in computer memory, it is difficult to calculate a similarity accurately as described above. So the problem of similarity calculation of sequences of historical locations is a technical problem rooted in computer technology.

One solution is to use dynamic time warping (DTW) to match a first sequence to a second sequence, such as by using the tslearn library https://tslearn.readthedocs.io/en/stable/index.html. DTW is a method that calculates an optimal match between two given sequences (e.g. time series) with certain restriction and rules:
Every index from the first sequence is matched with one or more indices from the other sequence and vice versa;
The first index from the first sequence is matched with the first index from the other sequence (but it does not have to be its only match)
The last index from the first sequence is matched with the last index from the other sequence (but it does not have to be its only match)
The mapping of the indices from the first sequence to indices from the other sequence is monotonically increasing, and vice versa, i.e. if j>i are indices from the first sequence, then there should not be two indices l>k in the other sequence, such that index i is matched with index l and index j is matched with index k, and vice versa

The optimal match is denoted by the match that satisfies all the restrictions and the rules and that has the minimal cost, where the cost is computed as the sum of absolute differences, for each matched pair of indices, between their values.

The absolute difference between two locations may be a distance measure, such as a geographical distance. The distance may be calculated by using a spherical Earth projected to a plane:

$$d = R \sqrt{{( Δϕ )}^{2} + {( cos ( {ϕ}_{m} ) Δλ )}^{2}} ,$$

where:
Δϕ and Δλ are the difference in latitude and longitude in radians, respectively. ϕₘ are in units compatible with the method used for determining cos(ϕₘ). To convert latitude or longitude to radians use 1°=(π/180)radians. The square root may be omitted for computational efficiency since only relative distances are used in DWT. In another example, the distance is expressed as the Haversine formula:

$$d = 2 r arcsin ( \sqrt{{sin}^{2} ( \frac{{φ}_{2} - {φ}_{1}}{2} ) + cos ( {φ}_{1} ) cos ( {φ}_{2} ) {sin}^{2} ( \frac{{λ}_{1} - {λ}_{2}}{2} )} )$$

where φ1, φ2 are the latitude of point 1 and latitude of point 2 (in radians), and λ1, λ2 are the longitude of point 1 and longitude of point 2 (in radians).

In yet a further example, the distance can be calculated as the Euclidean distance, which is more efficient but less accurate. In most cases, however, the Euclidean distances is still sufficiently accurate. The Euclidean distance is expressed as:

$$d ( p , q ) = \sqrt{{( {q}_{1} - {p}_{1} )}^{2} + {( {q}_{2} - {p}_{2} )}^{2}} .$$

between point p with coordinates (p₁, p₂) and point q with coordinates (q₁, q₂). These coordinates may be angles, such as longitude and latitude, which means the absolute distance is incorrect. However, the relative distance that is used herein is still correct.

Haversine, L1 (Manhattan), L2 (Euclidean) and some of the other metrics are available in scipy python package (https://www.scipy.org/). Common routes uses scipy as a general statisticts kit, hdbscan for clustering routes and tslearn for DTW and DTW barycenters. All three packages use numpy which makes them work well together. For instance, different space metrics from scikit can be used in hdbscan.

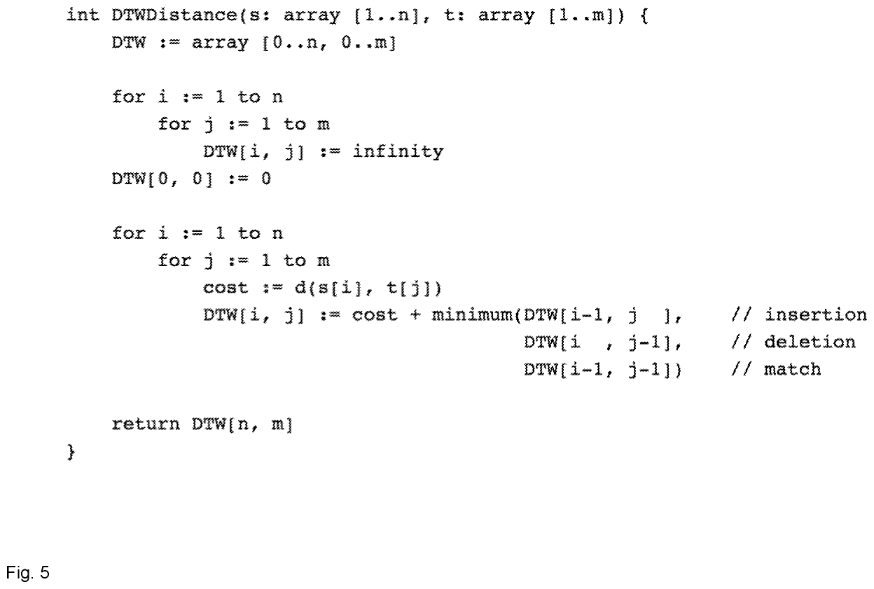

FIG. 5 shows an example implementation, where DTW[i, j] is the distance between s[1:i] and t[1:j] with the best alignment.

It is noted that

$$DTW [ i , j ] := cost + minimum ( DTW [ i - 1 , j ] , DTW [ i , j - 1 ] , DTW [ i - 1 , j - 1 ] )$$

provides that the cost of between two arrays with length i and j equals the distance between the tails+the minimum of cost in arrays with length i−1, j, i, j−1, and i−1, j−1.

In other words, the two sequences define a grid of indices, where the index of the first sequence is represented by the x-axis of the grid and the index of the second sequence is represented by the y-axis of the grid. A ‘1’ in the grid at an i/j position indicates that the i-th point of the first sequence is mapped to the j-th point of the second sequence. Finally, all points of the first sequence are mapped to at least one point of the second sequence and vice versa.

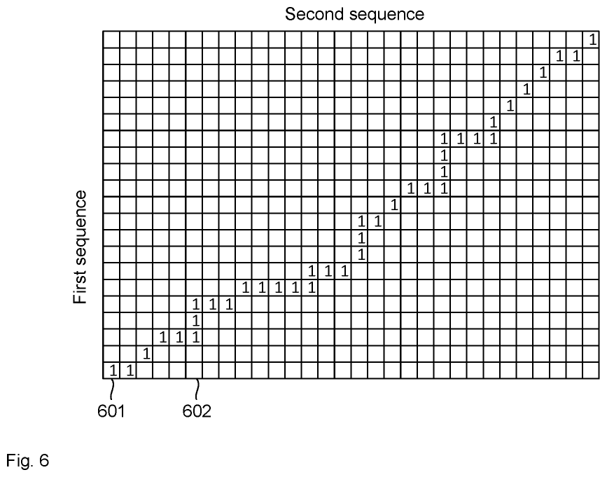

FIG. 6 illustrates a graphical representation of the grid, which is essentially an adjacency matrix that fulfils the requirements set out above. It can be seen, that some points in the first sequence are mapped to multiple points in the second sequence, which is shown as a horizontal repetition of ‘1’ entries. Other points in the second sequence are mapped to multiple points in the first sequence, which is shown as a vertical repetition of ‘1’ entries. Since each point in the first sequence is mapped to at least one point in the second sequence and the mapping is monotonic, the mapping, that is the ‘1’ entries in FIG. 6, define a path through the grid.

The number of possible mappings is exponential in the number of points in each sequence. So for example, in FIG. 6 the first sequence has 21 points, while the second sequence has 30 points. The number of possible mappings is therefore about 5E39. A computer using a graphical processing unit may be able to reach 12 teraflops. Assuming one path can be calculated in a single floating point operation, that computer would need 4E26 seconds, which is about 1E19 years, so about a trillion times longer than the age of the universe. This is clearly a technical problem that means a naïve software implementation is not practical on current computer hardware. Therefore, this disclosure provides implementation details that can overcome this obstacle.

In particular, the DTW algorithm used herein reduces this computational burden to seconds, noting that typical sequences contain many hundreds of data points as the corresponding vessel travels over vast distances and updates its position every few seconds. So the improvement in processing time is clearly a practical advantage of the proposed method.

One possible issue of the above algorithm is that it matches one element in an array with an unlimited number of elements in the other array (as long as the tail can match in the end), this would cause the mapping to bent over excessively, for example, the following array:

$$\begin{matrix}a = [ 1 , 2 , 3 ] \\ b = [ 1 , 2 , 2 , 2 , 2 , 2 , 2 , 2 , … , 5 ]\end{matrix}$$

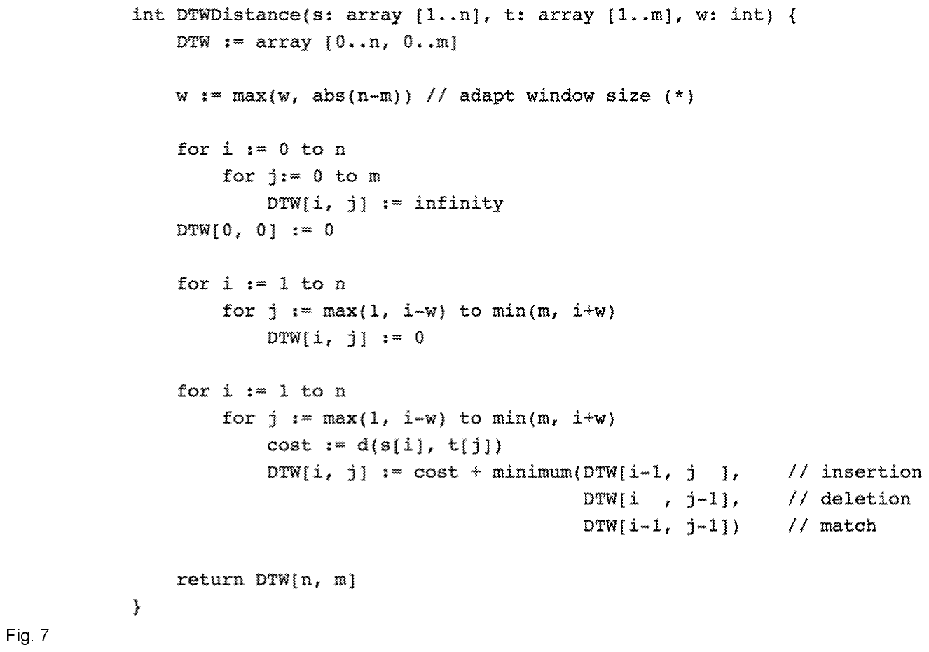

To minimise the distance, the element 2 in array a would match all the 2 in array b, which causes an array b to bent severely. To avoid this, it is possible to add a window constraint to limit the number of elements one can match. FIG. 7 illustrates a windowed DWT.

One difference is that now each element is confined to match elements in range i−w and i+w. The w:=max(w, abs(n−m)) guarantees all indices can be matched up. An example implementation of DTW is the fastdtw project on pypi.org accessible on: https://pypi.org/project/fastdtw/. Again, the use of a relational database, such as SQL, can greatly improve the computational efficiency of this method because the locations of one trip can be retrieved in one query based on the trip ID. As a result, all historical locations of that trip are essentially cached in RAM and can therefore be accessed immediately without recourse to slower persistent memory bus hardware.

In yet another example, the computer system uses a Sakoe-Chiba band in DTW, which also provides good optimization. The reason for this optimization step to work well has an intuitive explanation. If we compare two trajectories, both start at port A and end at port B, then it does not make much sense to map the first point of the first trajectory to the last point of the second trajectory. The first point of the first trajectory should be similar to some of the first n points of the second trajectory. The Sakoe-Chiba band therefore cuts off inadequate comparisons.

With either method above, the computer system stores the similarity measure in a similarity matrix where each point is the similarity measure between a pair of sequences.

### Clustering

Once a similarity measure, such as the DTW error, can be calculated between any two sequences, it is possible to use that measure to cluster the sequences that are similar according to the determined similarity, into multiple clusters of sequences by performing a clustering algorithm, such as k-means clustering or density-based spatial clustering of applications with noise (DBSCAN). It is noted that the clustering below assumes that each sequence is one data point for the purpose of clustering. So the clustering algorithm does not ‘see’ that each sequence has multiple locations sorted by respective timestamps. It is only the underlying DTW algorithm (or other possible alternatives), that accesses the locations directly and provides a single distance measure to the clustering algorithm. So, where the term ‘path’ is used below, this does not refer to the path of a vessel but to the path between two data points (each representing a sequence).

DBSCAN is a density-based clustering non-parametric algorithm: given a set of sequences in the space of DTT distance, it groups together sequences that are closely packed together (sequences with many nearby neighbour sequences), marking as outliers sequences that lie alone in low-density regions (whose nearest neighbours are too far away).

Let ε be a parameter specifying the radius (in terms of the DWT distance) of a neighbourhood with respect to some sequence. For the purpose of DBSCAN clustering, the sequences are classified as core sequences, (density-)reachable sequences and outliers, as follows:

A sequence p is a core sequence if at least minPts sequences are within DWT distance ε of it (including p). The minPts parameter can be set relatively low, or oven to 1, because there should be no sequences that are noise and even single sequences can be used as clusters in the next steps below.

A sequence q is directly reachable from p if sequence q is within distance ε from core sequence p. Sequences are only said to be directly reachable from core sequences.

A sequence q is reachable from p if there is a path p₁, . . . , pₙ with p₁=p and pₙ=q, where each pᵢ₊₁ is directly reachable from pᵢ. Note that this implies that the initial sequence and all sequences on the path must be core sequences, with the possible exception of q.

All sequences not reachable from any other sequence are outliers or noise sequences.

Now if p is a core sequence, then it forms a cluster together with all sequences (core or non-core) that are reachable from it. Each cluster contains at least one core sequence; non-core sequences can be part of a cluster, but they form its “edge”, since they cannot be used to reach more sequences.

Reachability is not a symmetric relation: by definition, only core sequences can reach non-core sequences. The opposite is not true, so a non-core sequence may be reachable, but nothing can be reached from it. Therefore, a further notion of connectedness is needed to formally define the extent of the clusters found by DBSCAN. Two sequences p and q are density-connected if there is a sequence o such that both p and q are reachable from o. Density-connectedness is symmetric.

A cluster then satisfies two properties:
All sequences within the cluster are mutually density-connected.
If a sequence is density-reachable from some sequence of the cluster, it is part of the cluster as well.

DBSCAN uses two parameters: ε and the minimum number of sequences required to form a dense region (minPts). It starts with an arbitrary starting sequence that has not been visited. This sequence's ε-neighbourhood is retrieved, and if it contains sufficiently many sequences, a cluster is started. Otherwise, the sequence is labelled as noise. Note that this sequence might later be found in a sufficiently sized ε-environment of a different sequence and hence be made part of a cluster.

If a sequence is found to be a dense part of a cluster, its ε-neighbourhood is also part of that cluster. Hence, all sequences that are found within the ε-neighbourhood are added, as is their own ε-neighbourhood when they are also dense. This process continues until the density-connected cluster is completely found. Then, a new unvisited sequence is retrieved and processed, leading to the discovery of a further cluster or noise.

DBSCAN can be used with any distance function (as well as similarity functions or other predicates). The distance function (dist) can therefore be seen as an additional parameter and can be set to the geographical distance set out above. Here, the distance function may be the DTW algorithm.

The DBSCAN algorithm can be abstracted into the following steps:
1. Find the sequences in the ε neighbourhood of every sequence, and identify the core sequences with more than minPts neighbours.
2. Find the connected components of core sequences on the neighbour graph, ignoring all non-core sequences.
3. Assign each non-core sequence to a nearby cluster if the cluster is an ε neighbour, otherwise assign it to noise.

The algorithm can be expressed in pseudocode as follows:

DBSCAN(DB, distFunc, eps, minPts) {

| | |
|---|---|
| C := 0 | /* Cluster counter */ |

```
  for each sequence P in database DB {
    if label(P) ≠ undefined then continue /* Previously
processed in inner loop */
```

| | |
|---|---|
| Neighbors N := RangeQuery(DB, distFunc, P, eps) | /* Find |

neighbours */

| | |
|---|---|
| if \|N\| < minPts then { | /* Density check */ |
| label(P) := Noise | /* Label as Noise */ |

```
      continue
    }
```

| | |
|---|---|
| C := C + 1 | /* next cluster label */ |
| label(P) := C | /* Label initial sequence */ |
| SeedSet S := N \ {P} | /* Neighbours to expand */ |
| for each sequence Q in S { | /* Process every seed sequence Q |

*/

| | |
|---|---|
| if label(Q) = Noise then label(Q) := C | /* Change |

Noise to border sequence */

| | |
|---|---|
| if label(Q) ≠ undefined then continue | /* |

Previously processed (e.g., border sequence) */

| | |
|---|---|
| label(Q) := C | /* Label neighbour */ |

| | |
|---|---|
| Neighbors N := RangeQuery(DB, distFunc, Q, eps) | /* Find |

neighbours */

| | |
|---|---|
| if \|N\| ≥ minPts then { | /* Density check (if Q is a |

core sequence) */

| | |
|---|---|
| S := S ∪ N | /* Add new neighbours to seed set */ |

```
      }
    }
  }
}
```

where RangeQuery can be implemented using a database index for better performance, or using a slow linear scan.

DBSCAN visits each sequence of the database, possibly multiple times (e.g., as candidates to different clusters). For practical considerations, however, the time complexity is mostly governed by the number of regionQuery invocations. DBSCAN executes exactly one such query for each sequence, and if an indexing structure is used that executes a neighbourhood in O(log n), an overall average runtime complexity of O(n log n) is obtained. For example, 100 log 100=460 and 1000 log 1000=6907, which is a moderate increase over linear growth, which shows that the clustering is computationally efficient, since the complexity does not rise exponentially.

The above method can be further improved by using HDBSCAN. H stands for Hierarchical. DBSCAN uses two parameters: Minimum cluster size and distance threshold, which is constant. The computer system first finds appropriate values for both parameters first. HDBSCAN on the other hand uses only minimum cluster size and therefore, HDBSCAN is an advancement over DBSCAN.

Clustering that uses less parameters (and hence makes less assumptions) is more beneficial for us as it reduces the number of error sources. In the case of DBSCAN epsilon and the cluster size may be sub-optimal. With HDBSCAN only the cluster size can be sub-optimal.

The computational complexity of the above algorithm can be further reduced by ranking the sequences between two ports by a number of metrics, such as entropy and path class. The computer system can then select only the top-ranked sequences instead of performing DTW on the entire set. This reduces the computational complexity significantly. After the best candidates are selected, the next optimization is to use DTW with the Sakoe-Chiba band optimization in phase 2.

Again, the HDBSCAN clustering algorithm is computationally efficient and uses DTW, which is also an efficient algorithm. In turn, DTW queries a SQL database, which has been highly optimised for computational efficiency. This example combination of three technical solutions SQL, DTW and HDBSCAN leads to a particularly efficient computer implementation as each software program builds on top of the advantages of the underlying program. In this particular example, HDBSCAN builds on the efficient distance calculation of DTW and the DTW calculation builds on the efficient query and retrieval of the SQL database. In such examples, the trips may be stored by adding the trip ID field value to each of the records of historical locations. Then, HDBSCAN can query the database for two trip IDs to then invoke DTW to calculate a distance between those two trip IDs. So when compared to other clustering algorithms that are described with reference to clustering ‘points’, each of the points is now represented by a trip ID that stands for a sequence indicative of a trip. Once the clustering is finished, the computer system can assign a cluster ID to each cluster, such as by enumeration or auto increment. The computer system then store the cluster ID as a further field with each location record. In other examples, the computer system uses a further data table that holds the trip IDs as records and for each trip ID record, the computer system stores a cluster ID. This way, the database reflects which trip belongs to which cluster.

It is noted that it is not essential that exactly these software programs are used, since other databases (relational, graph, CouchDB, Hadoop, etc.) combined with other distance measures and other clustering algorithms may lead to similar advantages.

### Representative Trip

The result of the clustering is a set of sequences that are in each cluster. The computer system can then determine one representative sequence (or “trip”) for the set of sequences that are in one cluster. This way, the representative sequence represents that cluster and the computer system repeats the process to determine multiple representative trips for respective clusters. In one example, the representative trip is the average of points of the multiple sequences in that cluster.

The average of points can also be calculated with the help of dynamic time warping (DWT), which is an available technique provided in various scientific papers and software libraries. Referring back to FIG. 6, the computer system may start with the longer sequence to retain more data points, which is the second sequence here. For each point of the second sequence, the computer system calculates the average of that point and all points from the first sequence that are mapped to that point. So for the first point of the second sequence, there is only one ‘1’ entry indicated at 601. Therefore, the computer system calculates the average of the first point of the second sequence and the first point of the first sequence. The result is the first point of the representative or average sequence.

For the sixth point of the second sequence indicated at 602, there are three points of the first sequence mapped to that point. Therefore, computer system calculates the average of those three points from the first sequence and the sixth point of the second sequence to calculate the sixth point of the representative or average sequence. This process is repeated until all points of the representative sequence are calculated. In another example, the computer system calculates the centroid (or geometric barycentre of the points that are mapped together to computer a natural looking time series average. The centroid may minimise the sum of squared Euclidean distances between itself and each of the points that are mapped together.

In cases where there are more than two sequences in a cluster, the computer system starts with two randomly selected sequences, calculates the average as described above and then selects a further random sequence and calculate the average between the previously calculated average sequence and the randomly selected further sequence. Instead of randomly selecting sequences, the computer system may start with the longest sequence and proceed in the order of descending length until all sequences are incorporated into the average sequence.

Another possible way to further optimise the averaging operation is by using DTW Barycenter Averaging (DBA). DBA iteratively refines an average sequence (starting from the medoid of the sequences) and follows an expectation-maximisation scheme:
1. Consider the average sequence fixed and find the best multiple alignment of the set of sequences with regard to the average sequence, by individually aligning each sequence to the average sequence.
2. Now consider M fixed and update the average sequence as the best average sequence consistent with M.

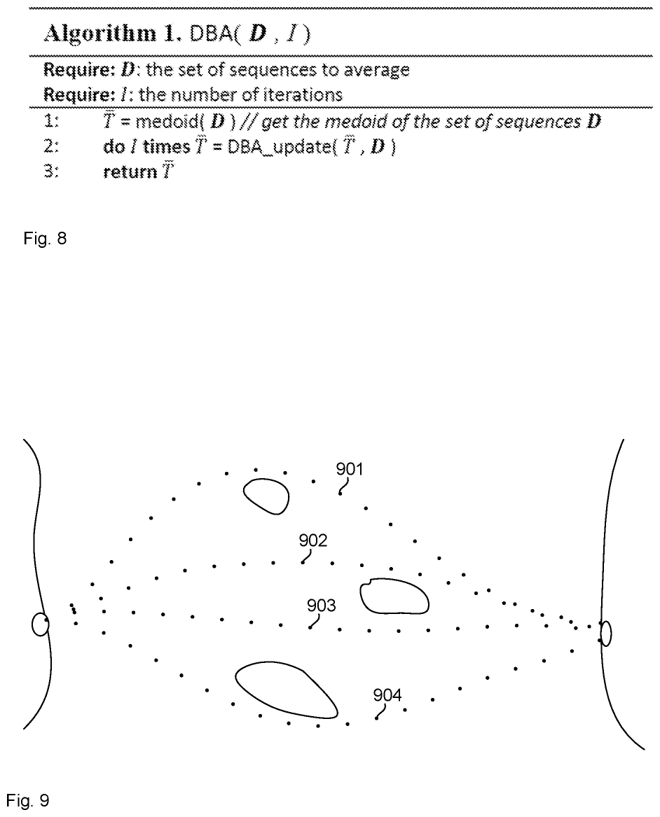

FIG. 8 illustrates an example pseudo-code for the DBA algorithm and FIG. 9 illustrates the output result of the DBA algorithm. In this example, the clustering identified four clusters and accordingly, the DBA algorithm calculated four representative sequences 901, 902, 903, 904. The computer system stores those representative sequences on a data store. While there is no need to re-compute these sequences, it may be useful to updated the sequences periodically to take into account any change in shipping routes.

In an example computer implementation, the computer system would query the database for one cluster ID. This may be a query for the table of trip records, rather than the table of location records. So the query returns all trip IDs that are stored with that one cluster ID. The computer system can then retrieve the sequence (i.e. list of historical locations) for each of these trip IDs to calculate their average as described above. Once the representative sequence is calculated, the computer system stores that in the database. For example, since the representative sequence is also a sequence of historical locations, it can be efficiently stored in the same table as the historical locations, with a new and unique trip ID. There may be yet a further table that associates that trip ID with a cluster ID, so that for each cluster, the computer system can efficiently retrieve the representative trip from the database by using a query for the cluster ID (potentially in a JOIN statement between the locations table and the cluster-to-trip table).

### Predicting Vessel Movement

It is noted that the preceding description relied on historical tracking data comprising historical locations. So for tracking a current vessel, that historical data is of limited use. However, as described above, the historical data is used to calculate representative sequences for respective clusters to thereby find common shipment routes.

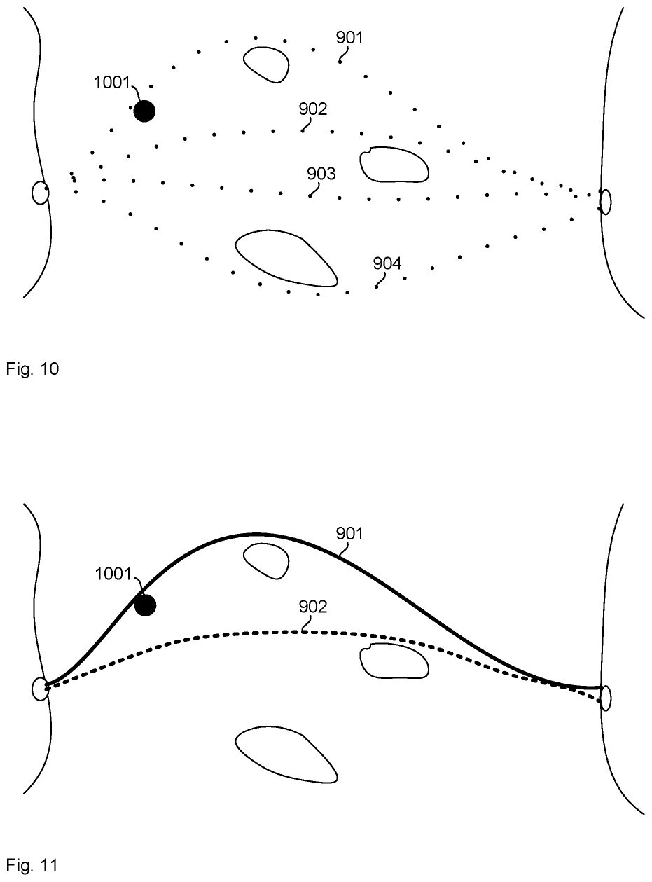

These representative sequences can be used for tracking a current vessel. More particularly, the computer system receives a current geographical location for a current trip of the tracked vessel. FIG. 10 illustrates the current location 1001 amongst the different representative sequences. It is noted that from the current location, it is not known which route the tracked vessel will take. As can be seen in FIG. 10, there are four routes that all lead to the same port. However, each of the four routes have a different travel time and would therefore lead to a different estimated time of arrival.

The computer system can now determine a similarity between the current location 1001 and the multiple representative sequences. For example, the computer system can calculate a geographical distance between the current location and each point of each of the sequences. The computer system then selects the sequence with the minimum distance. Other search algorithm may equally be used, such as a Monte Carlo search or a divide and conquer or bisection approach. The result is a minimum distance between the current location 1001 and each of the representative sequences.

The computer system then selects one of the multiple representative sequences 901, 902, 903, 904 that is similar to the geographical location 1001 according to the determined similarity (e.g., distance) between the geographical location and the multiple representative sequence 901, 902, 903, 904. FIG. 11 illustrates the scenario of FIG. 10 where representative sequence 901 has been selected and is now shown as a solid line, which could be presented in a user interface to a user. It is noted that FIG. 11 now shows the current location 1001 as well as the future path 901 that the vessel is predicted to take. Based on the current location alone, it would not be possible to predict that path. At most, the path could be predicted as being in a straight line from the current location 1001 to the destination. It can be seen from FIG. 11 that a straight line would be inaccurate compared to the actual prediction 901.

In that sense, the computer system predicts the future movement of the tracked vessel as proceeding along the selected sequence 901, which is one of the multiple representative sequences shown in FIG. 10.

In the example of an implementation with a relational database, the computer system may query the database for a list of cluster IDs, then for each cluster ID, query the database for location records of the representative sequence for that cluster ID, calculate the distance from the retrieved sequence and the current location and store the distance associated with the cluster ID. The computer system repeats these steps for every cluster ID to then select the cluster ID with the smallest distance.

In a further example, each cluster ID may have stored with it an origin and a destination. This way, the computer system can query for only those clusters that have the same origin and destination as the current vessel. This would significantly reduce the computational burden because not all clusters need to be matched against the current location.

The determination of the predicted path can be implemented with a statistical confidence value that indicates the confidence in the predicted path. The confidence can be calculated on a number of levels. For example, in FIG. 10, the confidence value may be inversely related to the distance of the current location 1001 to the selected path 901. So if the distance is zero, the confidence is 100%. Conversely, if the distance is greater than zero and below a maximum threshold, the confidence is between 100% and 0%. As a result, there may be multiple paths with a confidence value greater than 0%. In the example of FIG. 11 there is a second path 902 that is a worse match than path 901 but is still within the threshold distance. Therefore, the second path 902 can be reported as a low-confidence alternative solution. Further, it can be seen that the current location 1001 is not exactly on the first path 901, so the confidence for the first path is less than 100%. This confidence can be reported with first path 901 or the ETA that is calculated and reported as described below.

The confidence value may have further influencing factors. For example, during the clustering, the confidence value my rise closer to 100% if all sequences of that are relatively close to each other (low DTW distance). Conversely, if the clustered sequences are spread out, the confidence drops. Further, clusters with a higher number of sequences in them can be assigned a higher confidence value. This cluster confidence can be combined with the selection confidence above to calculate a total confidence, such as by multiplying both confidence values.

### Predictions

Based on the selected sequence or route 901, the computer system can now calculate an estimated time of arrival (ETA). For example, the computer system can calculate the length of route 901 and determine the speed of the vessel to estimate the ETA. Further, each route may have an associated typical travel time that can be used to calculate an ETA.

### Anomaly Detection

As stated above, a useful application for the methods disclosed herein is anomaly detection of vessels. More particularly, as set out herein, the computer system selects a representative trip (i.e. sequence) that is similar to the geographical location of the tracked vessel. Then, the computer system determines how closely the vessel follows that representative trip. If an updated geographical location is not closely located near the representative trip, an anomaly is detected. This could be the case if an updated vessel location is available but that location has a distance from the representative trip that is greater than a threshold distance (such as 1 nautical mile). So the computer system calculates a distance of a current geographical location and the selected representative trip. In response to the distance being determined to be greater than the threshold, an anomaly is detected. As a result, the computer system can generate an alert on a user interface or send alert messages, such as emails and SMSs. It is also possible to automatically initiate rescue or support operations, which may be useful if the anomaly occurs in a region that has a high risk of vessels being captured by pirates, for example.

### Computer Implementation

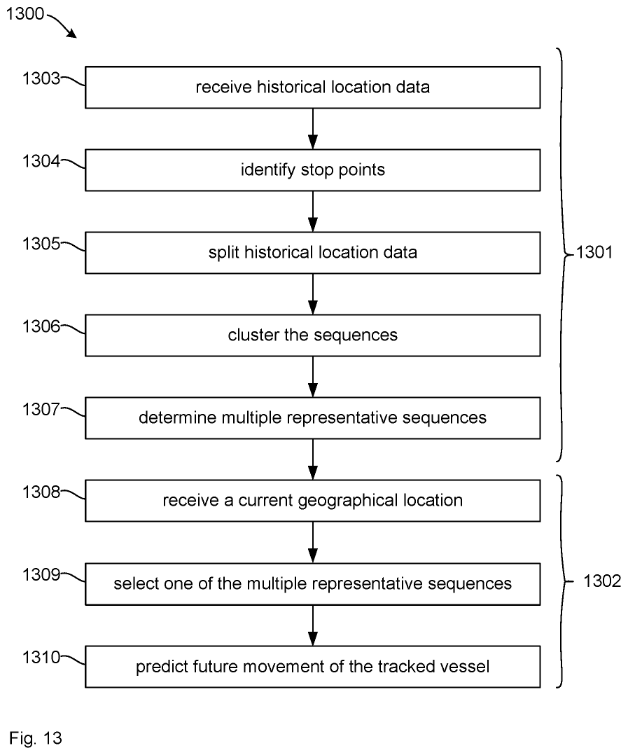

FIG. 12 illustrates a computer network 1200 comprising a first computer system 1201 and a second computer system 1211. First computer system 1201 comprises a processor 1202, non-transitory program memory 1203 and data memory 1204, which may be transitory, such as random access memory (RAM) or non-transitory, such as a hard disk drive. Processor 1202 executes program code stored on program memory 1203, which causes processor 1202 to perform the methods described herein, such as method 1300 shown FIG. 13 and described below. The program code stored on memory 1203 may also be referred to as a first software system. More particularly, the methods disclosed herein are implemented in a program language and then compiled into binary form and installed on program memory 1203, for example. The steps previously described as being performed by the server, are therefore performed by processor 1202 of first computing system 1201. In other words, first computing system 1201 is an example implementation of the server mentioned above.

First computer system 1201 further comprises a communication port to receive location data from a location data receiver 1206, which, in turn, receives the location data from a vessel 1207 over wireless communication. As described above, vessel 1207 may carry a GPS sensor and send the GPS coordinates wirelessly to receiver 1206. Other sensors may equally be used, such as Global Navigation Satellite System (GLONASS), BeiDou or Galileo. The location determined by satellite navigation using these systems may be improved by assistance technology, such as assisted GPS. Other non-satellite based location system, such as inertial navigation systems or dead reckoning may equally be used for location determination.

In further examples, the geographic location data comprises data from the automatic identification system (AIS), which may be transmitted from each vessel to a terrestrial receiver (T-AIS) or to a satellite (S-AIS). The data from the various different receivers may be aggregated and provided over the Internet. In that way, processor 1202 can receive the location data over the Internet, such as by calling API calls of a AIS data provider, such as MarineTraffic.com, Vesselfinder.com, or Spire Global, Inc.

Processor 1202 receives the geographic location data generated by receiver 1206 through communication port 1205, which maybe a wide area network (WAN) or local area network (LAN) interface. In other examples, processor 1202 receives the location data from database 1208 where historical location data is stored, such as recorded locations of all available vessels for the last year, for example.

FIG. 13 illustrates a method 1300 for predicting vessel movement. The method has two parts: a first part 1301 for creating historical trip data and a second part 1302 for predicting future vessel movement using the historical trip data.

In the first part 1301, processor 1202 receives 1303 historical location data indicative of historical locations of multiple vessels, such as AIS data recorded over a period of time, such as one year, one month, one week or a different time period. This has been described in more detail above with reference to FIG. 1. Processor 1202 then identifies 1304 stop points in the historical locations indicative of ports where the multiple vessels stopped. This has been described in more detail above with reference to FIGS. 2 and 3.

Processor 1202 then splits 1305 the historical location data for each of the multiple vessels into multiple sequences of historical locations between the stop points. Each of the multiple sequences represents one of multiple historical trips of the respective vessel. In essence, processor 1202 breaks down a relatively large data set into smaller pieces so that each of the data pieces can be used separately. More specifically, processor 1202 breaks the historical location data into multiple historical trips. This may involve splitting the data set into one sub-set for each of multiple vessels. So for example, the historical data may be AIS data and each data point may have a label indicating a vessel name. So processor 1202 can iterate over all vessel names and store the historical locations associate with that vessel in a separate data sub-set. While this already provides a reduction in the size of each sub-set, each sub-set may include historical location data of multiple trips for one vessel. This is the case because AIS data does not include a trip identifier or other data that indicates individual trips. This may be the case for other historical location data that is not AIS data. In other words, the historical location data may be a completely unordered and unstructured set of locations where each location has a label for a vessel name and a time stamp. Processor 1202 first splits the data set by vessel name and then splits the sub-set further into individual trips. This is done as set out above by identifying stop points and splitting the dataset at the stop points resulting in historical trips.

Splitting the data set may comprise storing the smaller split data sets separately by making a copy from the original data set or by labelling individual data points in the original data set by sub-set identifiers. For example, each data point may be stored in a relational database and that database may comprise a vessel identifier column and a trip identifier column. The value in the vessel identifier column may be the vessel name provided in the historical location data. Processor 1202 may maintain a counter that is incremented each time processor 1202 identifies a stop point and then assigs that counter value, i.e. sets the value for the trip identifier in the database, to all historical location up to the next stop point identified. This way, the processor 1202 splits the data set by assigning different trip identifiers to location data points.

Processor 1202 may determine a similarity between the sequences of historical locations, such as by using DTW, as described above with reference to FIG. 4. Then, processor 1202 performs clustering 1306 of the sequences of historical locations that are similar according to the determined similarity, into multiple clusters of sequences and finally, for the first part 1301, determines 1307 multiple representative sequences based on the multiple clusters of trips. An described with reference to FIG. 9, each representative sequence represents one of the multiple clusters.

In the second part 1302, processor 1202 can then predict future vessel movement based on the representative sequences. More particularly, processor 1202 receives 1308 a current geographical location for a current trip of a tracked vessel and may determine a similarity between the geographical location and the multiple representative sequences. Then, processor 1202 selects 1309 one of the multiple representative sequences that is similar to the geographical location according to the determined similarity between the geographical location and the multiple representative trips as described with reference to FIG. 11. Finally, processor 1202 predicts 1310 future movement of the tracked vessel as proceeding along the selected one of the multiple representative trips.

### Tracking Data Output

Once processor 1202 has determined the tracking data, such as by determining the predicted route the vessel will likely follow, processor 1202 may generate an event to notify second computer system 1211 of the determined route. Second computer system also comprises a second processor 1212, second program memory 1213, second data memory 1214 and a second database 1218. Program code that is installed on second program memory 1213 may also be referred to as the second software system. Second processor 1212 may provide an API that processor 1202 can call, such as by calling a web-API function at SecondComputerSystem.com/api/vesselDeparted?vesselID=123. The web location SecondComputerSystem.com may be replaced by an internet protocol (IP) address. As can be seen in this example, the API function call includes a vessel ID, which is 123 in this case. The API function call is an event generated by processor 1202 upon determining the predicted route.

It is also possible that first computer system 1202 exposes an API and second processor 1212 calls an update request function. Upon determining the predicted route 901, processor 1202 generates the event in the form of a response to the update request. That is, the generated event may be a change in value of a return variable.

In response to receiving the tracking data, such as through the API, the second computer system 1211 may perform an action, which is then said to be triggered by the event generated by the processor 1202 of the first computer system 1201.

While FIG. 12 illustrates an example computer network with two distinct hardware systems, it is noted that the described methods may equally be performed on the same hardware system, such that two software systems communicate with each other. In that sense, the first software system generates an event that triggers an action by the second software system. For example, the first and second computer systems 1201 may be implemented on a cloud computing environment on a dynamically changing number of computing and storage instances. The API calls provided below may also be replaced by function calls, or inter-process communication or by storing files with tracking data on non-transitory data memory 1204.

### Action Trigger

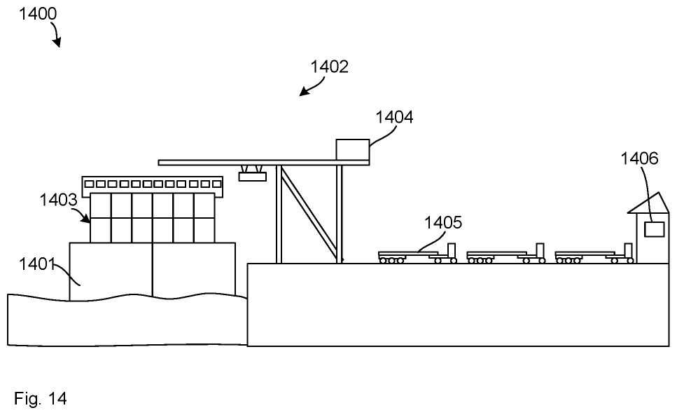

FIG. 14 illustrates an example port 1400 including a vessel 1401 docked at berth 1402. In this example, vessel 1401 is a container ship transporting a load of containers 1403. Port 1400 further comprises a gantry crane 1404 and a fleet of trucks, such as example truck 1405. Once the vessel 1401 is docked, the gantry crane 1404 loads the containers 1403 onto truck 1405 to transport them from port 1400 inland. There may also be intermediate storage It may be fairly typical way for the cargo of a large 18,000 twenty-foot equivalent unit (TEU) container ship to be distributed over 19 container trains (74 TEU each), 32 barges (97 TEU each) and 1,1260 trucks (1.6 TEU each, on average). This shows that the process of getting the containers onto the next mode of transport at minimal time is a significant technical challenge as the containers need to be moved in an optimal way.

A port controller 1406 performs port control based on the tracking data generated by processor 1202. It is also possible that port controller 1406 performs the method 1300 in FIG. 13 and generates the tracking data, such as a predicted route or an ETA. The determination of the route and/or ETA of a vessel triggers a range of actions. These actions may also be timed based on the departure or the ETA. For example, gantry crane 1404 is remote controlled by port controller 1406 and port controller 1406 generates control signals for gantry crane 1404 to move gantry crane 1404 to berth 1402, such that it arrives at the ETA, that is, at the same time, or slightly earlier, that the vessel 1401 is estimated to arrive.

Similarly, truck 1405 may be remote controlled and port controller 1406 generates control signals to control truck 1405 to arrive at berth 1402 at the ETA. In the case of a large number of trucks, such as over 1,000, a significant number of control signals are generated by port controller 1406. There may also be a mapping between specific containers to specific trucks and port controller 1406 may have information on where the containers are stored on vessel 1401. Therefore, port controller 1406 can determine an order or sequence of trucks to receive the containers as they are unloaded from the vessel. Again, port controller 1406 generates control signals for the trucks accordingly. Port controller 1406 may also generate signals that are to be provided to the drivers of the trucks to advise them of when to arrive at berth 1402.

While the above example shows how technically complex the automatic control of port equipment is, it should be noted that typical ports unload multiple vessels at the same time, which increases the complexity in the use of equipment even further. It is further noted that the accurate estimation of the arrival time enables the triggering of port actions. In other words, previous estimates were so inaccurate, that automatic control of port equipment would have led to technical difficulties, such as increased movement of vehicles leading to increased wear and tear and fuel consumption as well as blocking operations for other vessels. However, with the more accurately estimated arrival time, port equipment can be controlled automatically for all expected vessels simultaneously, so that the entire operation of the port is optimised. In that sense, wear and tear and fuel consumption is reduced. Further, the time for unloading cargo from the vessel onto trucks and then leaving the port on land, for example, is reduced because equipment is immediately ready at the estimated arrival time.

With an optimised port operation it is also possible to schedule berths further in advance. This means vessels can plan their trips more accurately, which would also mean that waiting times are reduced. This would lead to significant reduction in fuel consumption for idling engines during the wait. Further, vessels can reduce their travel speed if they are notified that the berth will not yet be available, leading to further reduction in fuel consumption.

While the example of FIG. 14 has been described with reference to cranes, vessels and trucks, it is to be understood that other types of port equipment can be controlled automatically by port controller 1406 and triggered by the determination of a predicted route. For example, the vessel may be a bulk carrier, such as for coal, oil, grain, or chemicals. Such a vessel requires bulk goods equipment and potentially trains to transport the bulk goods inland. This equipment and the trains may be remotely controlled by the port controller 1406 and triggered by the determination of the predicted route.

In yet a further example, the second software system is a cargo management system that tracks a large number of consignments, containers or shipments along multi-modal transport routes. In that case, the first software system may create an event to update the current status of the consignment, container or shipment in the second software system. For example, the status of a consignment, container or shipment may be changed by an action of the second software system triggered by the first software system, to indicate that the vessel, on which the current consignment, container or shipment is currently being transported, has left the port of origin. Further, the ETA at the destination port may be stored in association with that consignment, container or shipment. Also, the second software system may calculate the ETA at the final delivery destination by adding the estimated duration of further modes of transport to the ETA at the destination port.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for predicting vessel movement, the method comprising:
creating historical trip data by:
receiving historical location data indicative of historical locations of multiple vessels,
identifying stop points in the historical locations indicative of ports where the multiple vessels stopped,
splitting the historical location data for each of the multiple vessels into multiple sequences of historical locations between the stop points, each of the multiple sequences representing one of multiple historical trips of the respective vessel, and
clustering the multiple sequences of historical locations to determine multiple representative sequences, each representative sequence representing one of multiple clusters; and
predicting future vessel movement by:
receiving a current geographical location for a current trip of a tracked vessel,
selecting one of the multiple representative sequences that is close to the geographical location, and
predicting future movement of the tracked vessel as proceeding along the selected one of the multiple representative trips.

2. The method of claim 1, wherein the method comprises, during creating the historical trip data:
storing each of the multiple sequences as a separate record on a database;
performing the clustering by performing a query on the database for one or more stop points to retrieve records holding sequences comprising the one or more stop points of the query and clustering the sequences retrieved from the database.

3. The method of claim 2, wherein the database is a relational database.

4. The method of claim 1, wherein the method further comprises, during creating the historical trip data, filtering the historical location data by:
determining an information content in a time difference between the historical locations in each of the multiple sequences; and
selecting one or more of the multiple sequences that have a high information content for the clustering.

5. The method of claim 4, wherein determining the information content comprises determining an entropy of the historical locations.

6. The method of claim 4, wherein the method further comprises selecting one or more of the multiple historical trips that have a small variation in time difference between the historical locations.

7. The method of claim 1, wherein the method further comprises determining each representative sequence by calculating a barycentre average of the sequences of historical locations in each of the multiple clusters.

8. The method of claim 1, wherein the clustering comprises determining a similarity by warping the historical locations of a first sequence to determine an optimal match with the historical locations of a second sequence.

9. The method of claim 1, wherein the method further comprises a comparison between the prediction and an updated geographical location and determining an anomaly in the vessel movement based on the comparison.

10. (canceled)

11. The method of claim 1, wherein the prediction of vessel movement comprises a prediction that the tracked vessel will follow the selected one of the multiple representative sequences.

12. The method of claim 1, wherein the stop points are one or more of vessel origin and vessel destination.

13. The method of claim 1, wherein the method further comprises:
filtering the historical location data by one or more of vessel origin and vessel destination to select historical locations related to each of the multiple historical trips; and
using respective stop points for the one or more of vessel origin and vessel destination.

14. (canceled)

15. The method of claim 1, further comprising triggering, based on the prediction, events in a logistics application.

16. The method of claim 1, wherein the vessel movement is predicted by a first software system and the method further comprises generating, by the first software system, an event to notify a second software system of the predicted vessel movement and the method further comprises triggering, by the event, an action performed by the second software system.

17. (canceled)

18. The method of claim 1, wherein predicting the future movement of the vessel comprises calculating a probability of the future movement and the probability is indicative of a weight associated with the selected one of the multiple representative trips and the weight is indicative of a number of sequences in the cluster represented by the selected one of the multiple representative trips.

19. (canceled)

20. (canceled)

21. The method of claim 1, further comprising, storing the received historical location data on a relational database as multiple data records comprising one record for each of the historical locations wherein identifying the multiple historical trips comprises creating a field value for each of the records in the relational database indicative of a trip identifier to indicate an association between a data record and one of the multiple historical trips.

22. (canceled)

23. The method of claim 1, wherein
clustering comprises creating a field value indicative of an association between trip identifiers and cluster identifiers to indicate which trip belongs to which cluster, and
determining the multiple representative sequences comprises:
querying, based on one cluster identifier, the relational database for historical locations associated with a trip identifier that is associated with the one cluster identifier, and
averaging the returned sequences, as indicated by trip identifiers, to determine one of the multiple representative sequences.

24. The method of claim 1, wherein performing the method comprises running a first service and a second service,
the first service is configured to perform the steps of receiving the historical location data, identifying stop points, and splitting the historical location data into the multiple sequences, the first service further stores the multiple sequences on a database; and
the second service is configured to retrieve the sequences from the database for the clustering of the sequences.

25. A non-transitory, computer readable medium with program code stored thereon that, when executed by a computer, causes the computer to perform the method of claim 1.

26. A computer system for predicting vessel movement, the computer system comprising:
a data store configured to store historical location data indicative of historical locations of multiple vessels;
a processor configured to create historical trip data by:
identifying stop points in the historical locations indicative of ports where the multiple vessels stopped;
splitting the historical location data for each of the multiple vessels into multiple sequences of historical locations between the stop points, each of the multiple sequences representing one of multiple historical trips of the respective vessel;
clustering the multiple sequences of historical locations to determine multiple representative sequences, each representative sequence representing one of multiple clusters;
the processor being further configured to predict future vessel movement by:
receiving a current geographical location for a current trip of a tracked vessel;
selecting one of the multiple representative sequences that is close to the geographical location;
predicting future movement of the tracked vessel as proceeding along the selected one of the multiple representative trips.

27. (canceled)
